(19) United States
(12) Patent Application Publication
(10) Pub. No.: US 2008/0267825 A1
(43) Pub. Date: Oct. 30, 2008

(54) Gas detecting apparatus

(75) Inventors: Toshihiro Ogasawara, Tokyo (JP); Yoshihiro Asakawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/010,552

(22) Filed: Jan. 25, 2008

(30) Foreign Application Priority Data
Jan. 26, 2007 (JP) 2007-016642

(51) Int. Cl. G01J 1/48

(52) U.S. Cl. 422/87

(57) ABSTRACT

A gas detecting apparatus includes a plate including a first reactive surface and a second reactive surface each coated with a chemical reagent which is capable of causing a color reaction with a particular gas, a protective member covering the first reactive surface, a transparent protective member covering the second reactive surface, a protective package enclosing therein the plate with the first reactive surface covered with the protective member and the second reactive surface covered with the transparent protective member, and a connector connecting the protective member and the protective package to each other.

This application is based upon and claims the benefit of priority from Japanese patent application No. 2007-16642, filed on Jan. 26, 2007, the disclosure of which is incorporated herein in its entirety by reference.

### BACKGROUND OF THE INVENTION

1. Field of the Invention

The present invention relates to a gas detecting apparatus, and more particularly to a gas detecting apparatus for allowing a chemical reagent to cause a color reaction with a particular gas on a reactive surface.

2. Description of the Related Art

There have heretofore been known gas detecting devices for causing a chemical reaction between a gas such as a toxic gas and a chemical reagent to change the color of the chemical reagent. For example, U.S. Pat. No. 6,228,657B1 discloses an M256 chemical agent detection kit.

FIG. 1A is a diagram showing an M256 chemical agent detection kit.

As shown in FIG. 1A, M256 chemical agent detection kit 100 includes plate 103 having two reactive surfaces 101 and 102, chemical reagent 104 in the form of a tablet, and plate 105 that is bendable and vertically movable to rub chemical reagent 104 against reactive surfaces 101 and 102.

FIG. 1B is a cross-sectional view of the M256 chemical agent detection kit that is enclosed in protective package 106. When M256 chemical agent detection kit 100 is enclosed in protective package 106, M256 chemical agent detection kit 100 is shielded from the environment such as ambient air. Those parts shown in FIG. 1B which are identical to those shown in FIG. 1A are denoted by identical reference characters.

FIGS. 2A through 2C are perspective views showing the manner in which the M256 chemical agent detection kit is used.

The user removes M256 chemical agent detection kit 100 from protective package 106 and bends plate 105 to rub chemical reagent 104 against reactive surface 101 (see FIG. 2A).

The user leaves M256 chemical agent detection kit 100 in a gaseous atmosphere for a certain period of time (see FIG. 2B). At this time, if the gaseous atmosphere contains a particular gas, then chemical reagent 104 on reactive surface 101 causes a color reaction with the particular gas.

Thereafter, the user bends plate 105 again to rub chemical reagent 104 against reactive surface 102. The user compares the color of reactive surface 101 (specifically, the color of chemical reagent 104 on reactive surface 101) and the color of reactive surface 102 (specifically, the color of chemical reagent 104 on reactive surface 102) with each other to determine whether the certain gas is present in the gaseous atmosphere or not (see FIG. 2C).

The process shown in FIGS. 2A through 2C is disadvantageous in that the user needs to perform a tedious and time-consuming task of manually rubbing chemical reagent 104 in the form of a tablet against reactive surfaces 101 and 102 for identifying the particular gas.

### SUMMARY OF THE INVENTION

An exemplary object of the invention is to provide a gas detecting apparatus which is capable of detecting a gas without the user has to rub a chemical reagent against reactive surfaces.

A gas detecting apparatus according to an exemplary aspect of the invention includes a plate including a first reactive surface and a second reactive surface each coated with a chemical reagent which is capable of causing a color reaction with a particular gas; a protective member covering the first reactive surface; a transparent protective member covering the second reactive surface; a protective package enclosing therein the plate with the first reactive surface covered with the protective member and the second reactive surface covered with the transparent protective member; and a connector connecting the protective member and the protective package to each other.

The above and other objects, features, and advantages of the present invention will become apparent from the following description with reference to the accompanying drawings which illustrate an example of the present invention.

### BRIEF DESCRIPTION OF THE DRAWINGS

FIG. 1A is a perspective view of an M256 chemical agent detection kit;

FIG. 1B is a cross-sectional view of the M256 chemical agent detection kit;

FIG. 2A is a perspective view showing the manner in which the M256 chemical agent detection kit is used;

FIG. 2B is a perspective view showing the manner in which the M256 chemical agent detection kit is used;

FIG. 2C is a perspective view showing the manner in which the M256 chemical agent detection kit is used;

FIG. 3 is a cross-sectional view of a gas detecting device according to an embodiment of the present invention;

FIG. 4 is a perspective view of a plate, a transparent protective sheet, and another transparent protective sheet, which are shown as separate from each other, of the gas detecting device shown in FIG. 3;

FIG. 5 is a perspective view of a sheet-combined reactive plate;

FIG. 6A is a cross-sectional view of the gas detecting device while the sheet-combined reactive plate is being enclosed in a protective package;

FIG. 6B is a cross-sectional view of the gas detecting device while the sheet-combined reactive plate is being removed from the protective package;

FIG. 6C is a cross-sectional view of the sheet-combined reactive plate removed from the protective package;

FIG. 7A is a perspective view showing the manner in which the gas detecting device is used;

FIG. 7B is a perspective view showing the manner in which the gas detecting device is used;

FIG. 7C is a perspective view showing the manner in which the gas detecting device is used; and

FIG. 8 is a cross-sectional view of a gas detecting device according to another embodiment of the present invention.

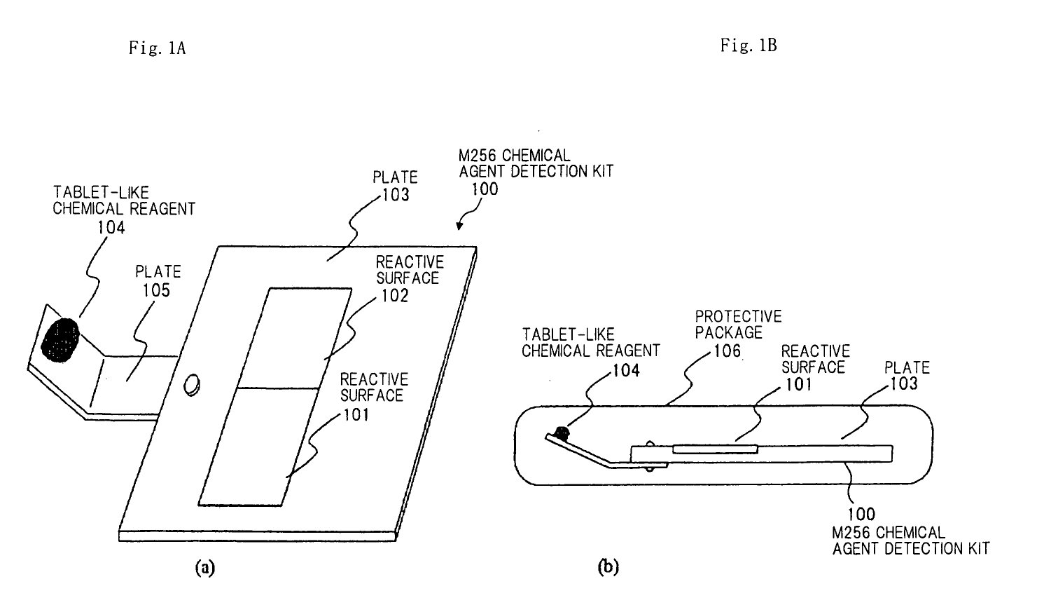

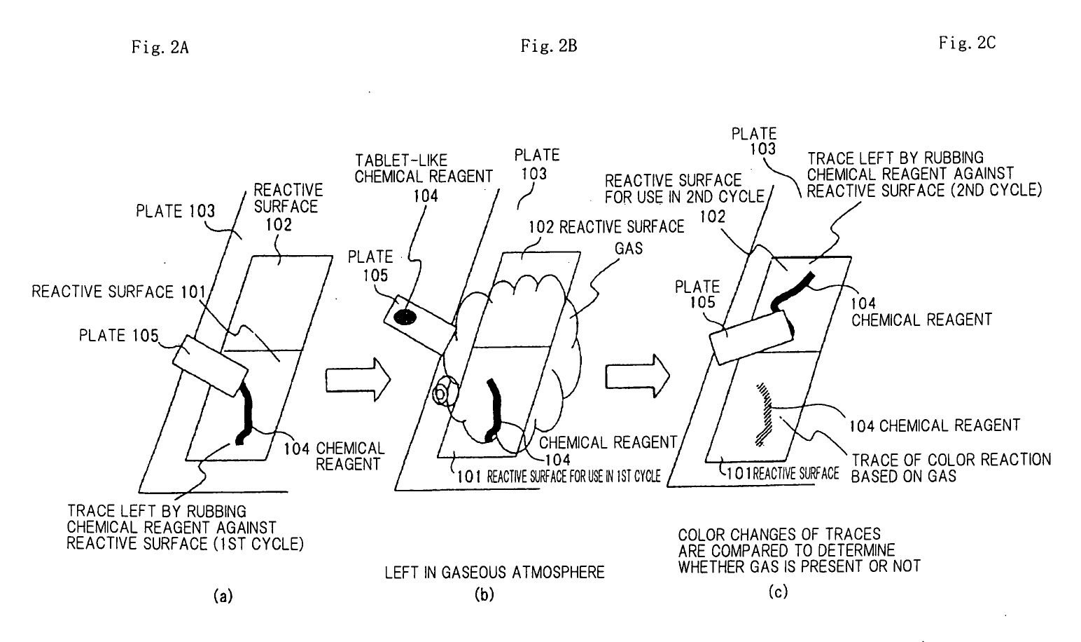

### DETAILED DESCRIPTION OF THE PREFERRED EMBODIMENTS

Gas detecting devices according to preferred embodiments of the present invention will be described below with reference to the drawings.

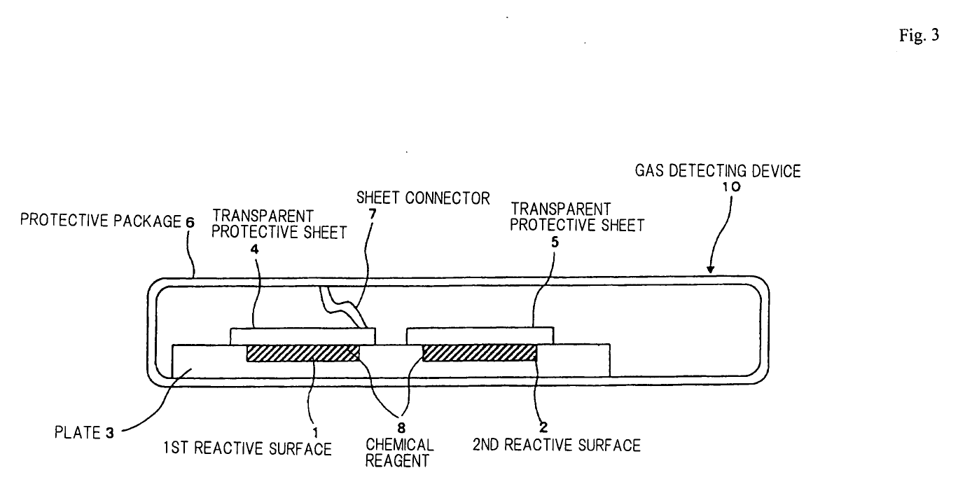

FIG. 3 shows in cross section gas detecting device 10 according to an embodiment of the present invention.

As shown in FIG. 3, gas detecting device 10 comprises plate 3 including first reactive surface 1 and second reactive surface 2, transparent protective sheet 4 covering first reactive surface 1, transparent protective sheet 5 covering second reactive surface 2, protective package 6 which encloses therein plate 3 including first reactive surface 1 covered with transparent protective sheet 4 and second reactive surface 2 covered with transparent protective sheet 5, and sheet connector 7 connecting transparent protective sheet 4 to protective package 6.

Plate 3 can generally be called plate means.

Each of first reactive surface 1 and second reactive surface 2 is made of paper, for example. Each of first reactive surface 1 and second reactive surface 2 is coated with a uniform layer of chemical reagent 8 in a solid or liquid phase, chemical reagent 8 having the same components as the tablet-shaped chemical reagent of the related art. Chemical reagent 8 causes a color reaction with a particular gas.

The surface of plate 3 which is exclusive of first reactive surface 1 and second reactive surface 2 is not coated with chemical reagent 8, and serves as a dead zone.

Transparent protective sheet 4 can generally be called protective means.

Transparent protective sheet 4 is an example of protective member and prevents first reactive surface 1 from contacting ambient air containing gases, oxygen, and humidity. The protective member does not need to be transparent. Transparent protective sheet 4 is peelably bonded to surface areas of plate 3 which surround first reactive surface 1 by an adhesive with weak adhesive power. Such an adhesive with weak adhesive power is of known nature.

Transparent protective sheet 5 can generally be called transparent protective means.

Transparent protective sheet 5 is an example of transparent protective member and prevents second reactive surface 2 from contacting ambient air containing gases, oxygen, and humidity. Transparent protective sheet 5 is peelably bonded to surface areas of plate 3 which surround second reactive surface 2 by an adhesive with weak adhesive power. Transparent protective sheet 5 may be firmly secured to the surface areas of plate 3 which surround second reactive surface 2.

Sheet 3 with transparent protective sheet 4 and transparent protective sheet 5 attached thereto will hereinafter referred to as “sheet-combined reactive plate 3A”.

Protective package 6 can generally be called protective package means.

Protective package 6 encloses sheet-combined reactive plate 3A therein.

Sheet connector 7 can generally be called connector means.

Sheet connector 7 is an example of connector and connects protective package 6 and transparent protective sheet 4 to each other.

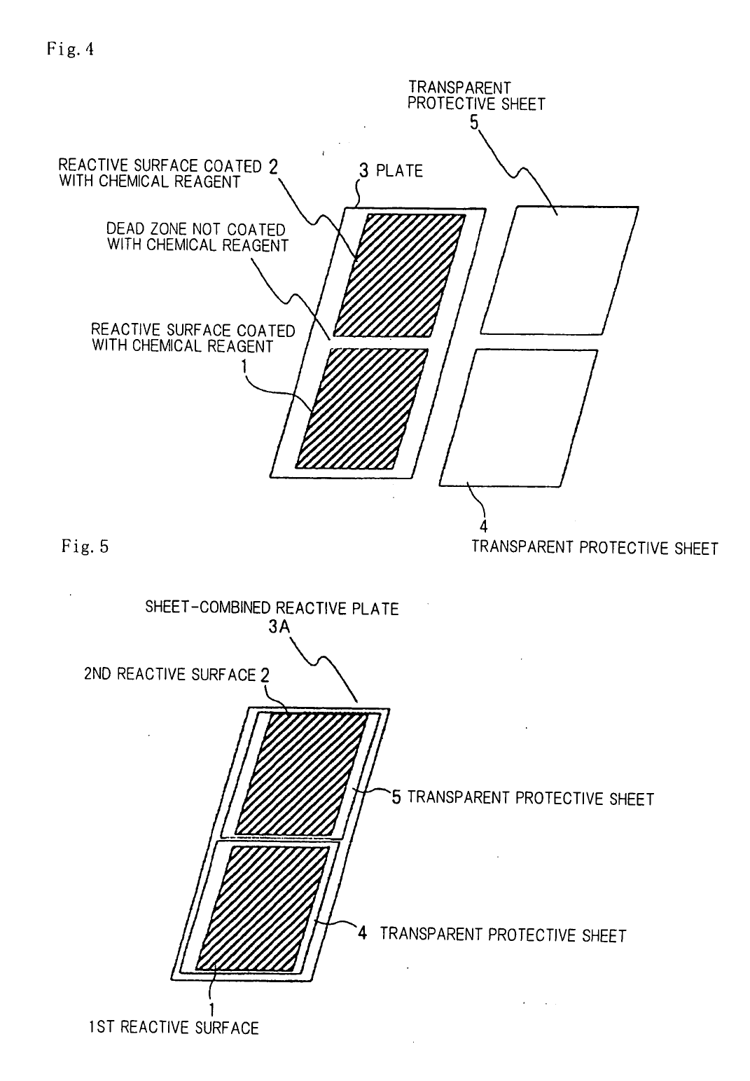

FIG. 4 shows in perspective plate 3, transparent protective sheet 4, and transparent protective sheet 5, which are shown as separate from each other. FIG. 5 shows in perspective transparent protective sheet 4 and trans-parent protective sheet 5 that are bonded to plate 3, i.e., sheet-combined reactive plate 3A. Those parts shown in FIGS. 4 and 5 which are identical to those shown in FIG. 3 are denoted by identical reference characters.

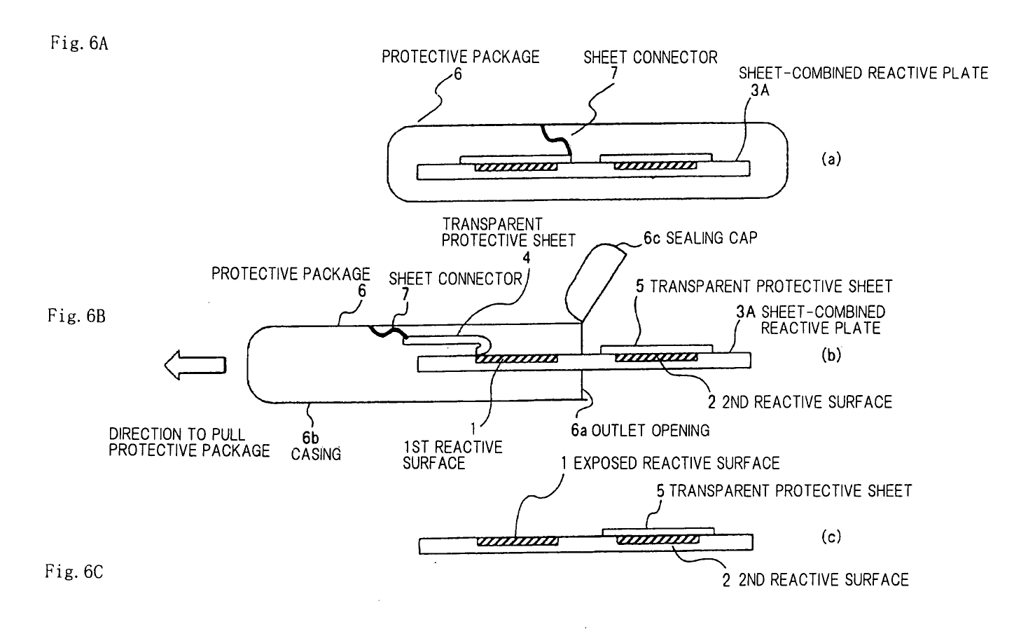

FIGS. 6A through 6C are views showing the manner in which sheet-combined reactive plate 3A is removed from protective package 6. Those parts shown in FIGS. 6A through 6C which are identical to those shown in FIG. 3 are denoted by identical reference characters.

FIG. 6A shows in cross section gas detecting device 10 while sheet-combined reactive plate 3A is being enclosed in protective package 6. While sheet-combined reactive plate 3A is being enclosed in protective package 6, first reactive surface 1 and second reactive surface 2 are not exposed to an ambient air atmosphere.

FIG. 6B shows in cross section gas detecting device 10 while sheet-combined reactive plate 3A is being removed from protective package 6. As sheet-combined reactive plate 3A is removed from protective package 6, transparent protective sheet 4 is peeled off first reactive surface 1 by sheet connector 7 that is connected to protective package 6.

Protective package 6 includes casing 6b having outlet opening 6a for removing sheet-combined reactive plate 3A therethrough and sealing cap 6c for sealing outlet opening 6a.

FIG. 6C shows in cross section sheet-combined reactive plate 3A removed from protective package 6 with transparent protective sheet 4 peeled off first reactive surface 1, exposing first reactive surface 1 to the ambient air atmosphere. Second reactive surface 2 remains covered with transparent protective sheet 5, reactive surface 2 is not exposed to the ambient air atmosphere.

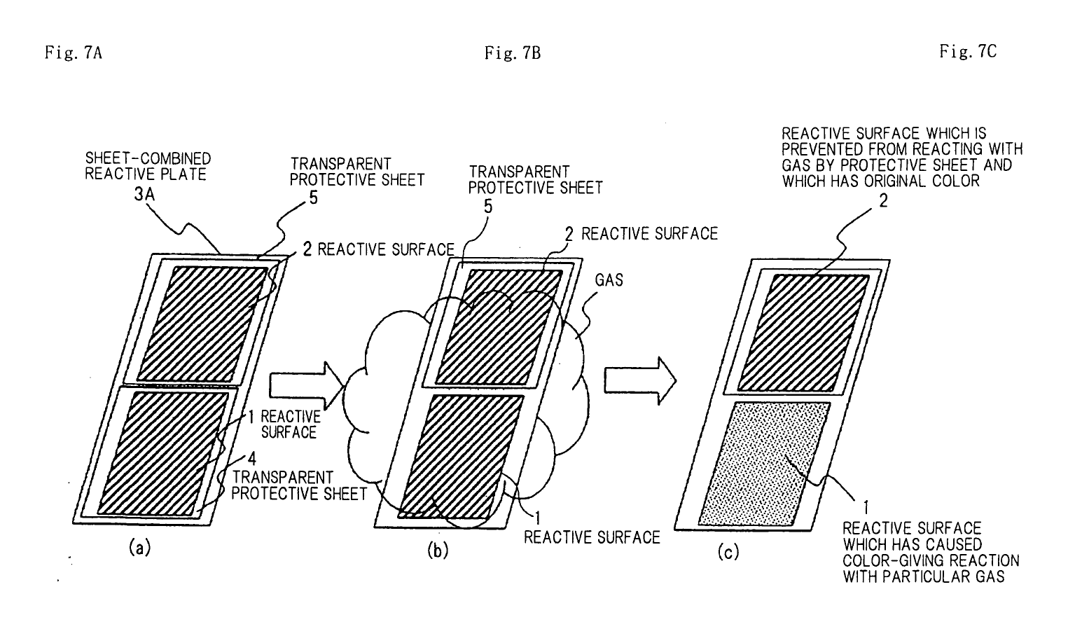

FIGS. 7A through 7C show in perspective the manner in which gas detecting device 10 is used. Those parts shown in FIGS. 7A through 7C which are identical to those shown in FIG. 3 are denoted by identical reference characters.

FIG. 7A shows in perspective sheet-combined reactive plate 3A while it is being enclosed in protective package 6 (not shown). At this time, transparent protective sheet 4 is attached to first reactive surface 1, and transparent protective sheet 5 is attached to second reactive surface 2.

FIG. 7B shows in perspective sheet-combined reactive plate 3A removed from protective package 6. As shown in FIG. 7B, transparent protective sheet 4 is peeled off first reactive surface 1, exposing first reactive surface 1 to the ambient air atmosphere.

If the ambient air atmosphere contains the particular gas, since first reactive surface 1 is exposed to the ambient air atmosphere, chemical reagent 8 applied to first reactive surface 1 causes a color reaction with the particular gas in the ambient air atmosphere. Chemical reagent 8 applied to second reactive surface 2 does not cause a color reaction with the particular gas as second reactive surface 2 is covered with transparent protective sheet 5.

FIG. 7C shows in perspective exposed first reactive surface 1 which has caused the color reaction with the particular gas, or more specifically, chemical reagent 8 which has caused the color reaction with the particular gas. The user can determine whether the ambient air atmosphere contains the particular gas or not by comparing the color of first reactive surface 1 and the color of second reactive surface 1 for the color difference.

According to the present embodiment, when sheet-combined reactive plate 3A is removed from protective package 6 for the detection of a gas, transparent protective sheet 4 is peeled off first reactive surface 1 by sheet connector 7. At this time, second reactive surface 2 remains covered with transparent protective sheet 5.

When plate 3 is placed in the ambient air atmosphere containing the particular gas, chemical reagent 8 applied to first reactive surface 1 causes a color reaction with the particular gas, changing the color of chemical reagent 8. The color of chemical reagent 8 applied to second reactive surface 2 remains unchanged.

The user does not need to rub the chemical reagent against the reactive surfaces, as is the case with the related art, but simply compares the color of the first reactive surface and the color of the second reactive surface with each other to determine whether the particular gas is present in the ambient air atmosphere or not.

As the user is not required to manually rub the chemical reagent against the reactive surfaces, the entire reactive surfaces may be coated with a uniform layer of chemical reagent by a coating machine, for example.

Since the chemical reagent does not need to be manually rubbed against the reactive surfaces by the user, the amounts of chemical reagent applied to the reactive surfaces are prevented from varying from individual to individual, and the colors of the reactive surfaces can be determined quantitatively.

According to the present embodiment, the protective member (trans-parent protective sheet 4) is transparent. Therefore, the user can confirm the color of the chemical reagent covered with the protective member, and can easily discover an anomaly, e.g., a discoloration, of the chemical reagent. The protective member and the transparent protective member (transparent protective sheet 5) may be made of the same material.

According to the present embodiment, transparent protective sheet 4 is peelably bonded to surface areas of plate 3 which surround first reactive surface 1 by the adhesive with weak adhesive power. As long as first reactive surface 1 is covered with transparent protective sheet 4, first reactive surface 1 is prevented from contacting the ambient air with high probability. Since the adhesive stays out of contact with first reactive surface 1, first reactive surface 1 is free from defects which would otherwise result from contact with the adhesive, e.g., damage, chemical reagent discoloration, adhesive coating, etc.

According to the present embodiment, transparent protective sheet 5 is also peelably bonded to the surface areas of plate 3 which surround first reactive surface 1 by the adhesive with weak adhesive power. Therefore, second reactive surface 2 is prevented from contacting the ambient air with high probability. Since the adhesive stays out of contact with second reactive surface 2, second reactive surface 2 is free from defects which would otherwise result from contact with the adhesive, e.g., damage, chemical reagent discoloration, adhesive coating, etc.

According to the present embodiment, protective package 6 includes casing 6b and sealing cap 6c. Therefore, sheet-combined reactive plate 3A can be hermetically enclosed in protective package 6 to protect first reactive surface 1 and second reactive surface 2 sufficiently from the ambient air.

The illustrated structural details according to the above embodiment are shown by way of example only, and the present invention is not limited to those structural details.

For example, the protective member covering first reactive surface 1 is not limited to transparent protective sheet 4, but may be changed or modified. For example, the protective member covering first reactive surface 1 may comprise a pouch-like cover covering first reactive surface 1. The trans-parent protective member covering second reactive surface 2 is not limited to transparent protective sheet 5, but may be changed or modified. For example, the transparent protective member covering second reactive surface 2 may comprise a pouch-like cover covering second reactive surface 2.

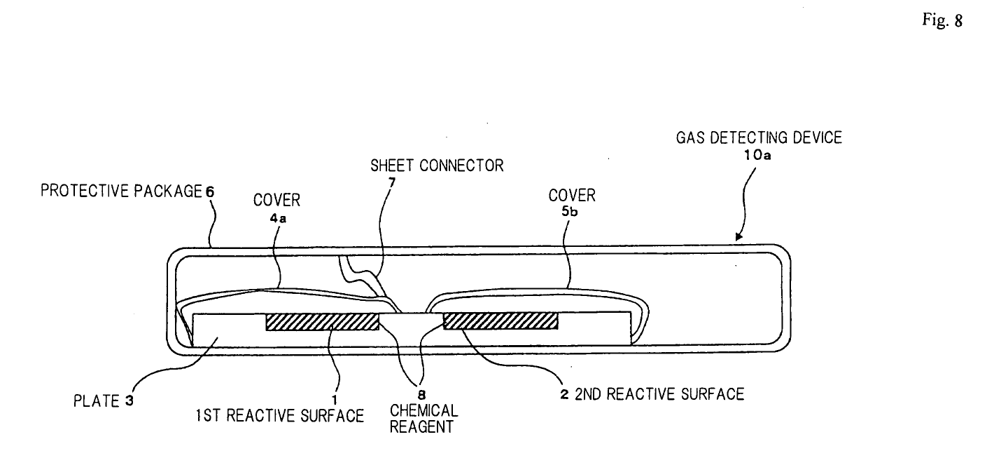

FIG. 8 shows in cross section gas detecting device 10a according to another embodiment of the present invention, which includes pouch-like cover 4a as a protective member covering first reactive surface 1 and pouch-like cover 5a as a transparent protective member covering second reactive surface 2. Those parts shown in FIG. 8 which are identical to those shown in FIG. 3 are denoted by identical reference characters.

When plate 3 is removed from protective package 6 of gas detecting device 10a shown in FIG. 8, cover 4a is torn off by sheet connector 7, exposing first reactive surface 1 to the ambient air atmosphere.

According to the above embodiments, when the sheet-combined reactive plate is removed from the protective package for the detection of a gas, the protective member is peeled off the first reactive surface by the sheet connector which connects the protective package and the protective member to each other.

Since the first reactive surface is coated with the chemical reagent, when the sheet-combined reactive plate removed from the protective package is placed in the atmosphere containing the particular gas, the chemical reagent applied to the first reactive surface causes a color reaction with the particular gas. The chemical reagent applied to the second reactive surface does not change its color because the second reactive surface is covered with the transparent protective member.

Therefore, the user does not need to rub the chemical reagent against the reactive surfaces, but simply compares the color of the first reactive surface and the color of the second reactive surface with each other to determine whether the particular gas is present in the ambient air atmosphere or not.

The protective member should preferably be transparent.

With the transparent protective member, the user can easily discover an anomaly of the chemical reagent covered with the protective member. The protective member and the transparent protective member may be made of the same material.

The protective member should preferably comprise a protective sheet peelably bonded to surface areas of the plate which surround the first reactive surface.

As long as the first reactive surface is covered with the protective sheet, the first reactive surface is prevented from contacting the ambient air with high probability.

The transparent protective member should preferably comprise a transparent protective sheet peelably bonded to surface areas of the plate which surround the second reactive surface.

The second reactive surface covered with the transparent protective sheet is prevented from contacting the ambient air with high probability.

Alternatively, the protective member should preferably comprise a pouch-like cover covering the first reactive surface.

As long as the first reactive surface is covered with the pouch-like cover, the first reactive surface is prevented from contacting the ambient air with high probability.

Alternatively, the transparent protective member should preferably comprise a pouch-like cover covering the second reactive surface.

The second reactive surface covered with the pouch-like cover is prevented from contacting the ambient air with high probability.

The protective package should preferably include a casing having an outlet opening for removing the plate therethrough and a sealing cap for sealing the outlet opening.

Therefore, the plate can be hermetically enclosed in the protective package to protect the first reactive surface and the second reactive surface sufficiently from the ambient air.

An exemplary advantage according to the present invention is that a gas can be detected without a user has to rub a chemical reagent against reactive surfaces.

While an exemplary embodiment of the present invention has been described using specific terms, such description is for illustrative purposes only, and it is to be understood that changes and variations may be made without departing from the spirit or scope of the following claims.

What is claimed is:

1. A gas detecting apparatus comprising:
a plate including a first reactive surface and a second reactive surface each coated with a chemical reagent which is capable of causing a color reaction with a particular gas;
a protective member covering said first reactive surface;
a transparent protective member covering said second reactive surface;
a protective package enclosing therein said plate with said first reactive surface covered with said protective member and said second reactive surface covered with said transparent protective member; and
a connector connecting said protective member and said protective package to each other.

2. The gas detecting apparatus according to claim 1, wherein said protective member is transparent.

3. The gas detecting apparatus according to claim 1, wherein said protective member comprises a protective sheet peelably bonded to surface areas of said plate which surround said first reactive surface.

4. The gas detecting apparatus according to claim 1, wherein said transparent protective member comprises a transparent protective sheet peelably bonded to surface areas of said plate which surround said second reactive surface.

5. The gas detecting apparatus according to claim 1, wherein said protective member comprises a pouch-like cover covering said first reactive surface.

6. The gas detecting apparatus according to claim 1, wherein said transparent protective member comprises a pouch-like cover covering said second reactive surface.

7. The gas detecting apparatus according to claim 1, wherein said protective package comprises a casing including an outlet opening for removing said plate therethrough and a sealing cap for sealing said outlet opening.

8. A gas detecting apparatus comprising:
plate means including a first reactive surface and a second reactive surface each coated with a chemical reagent which is capable of causing a color reaction with a particular gas;
protective means for covering said first reactive surface;
transparent protective means for covering said second reactive surface;
protective package means for enclosing therein said plate means with said first reactive surface covered with said protective means and said second reactive surface covered with said transparent protective means; and
connector means for connecting said protective means and said protective package means to each other.
